(19) United States
(12) Patent Application Publication
(10) Pub. No.: US 2026/0069085 A1
(43) Pub. Date: Mar. 12, 2026

(54) SYSTEM AND METHOD FOR A WEARABLE GRINDER

(71) Applicant: Ira TURPIN, IV, Washington, DC (US)

(72) Inventor: Ira TURPIN, IV, Washington, DC (US)

(21) Appl. No.: 18/884,068

(22) Filed: Sep. 12, 2024

(51) Int. Cl. A47J 42/34

(52) U.S. Cl. CPC A47J 42/34

(57) ABSTRACT

The present invention includes an apparatus for grinding herbs comprising at least one wearable grinder, having a bottom end and a top end, and having an exterior surface and an interior surface; wherein the bottom end includes a cavity configured to be worn on the digit of a person; and wherein the top end includes a grinding surface located on the exterior surface of the wearable herb grinder, said grinding surface having a texture configured for grinding.

### TECHNICAL FIELD

The present disclosure relates to grinders, but more specifically to manually wearable grinding devices.

### BACKGROUND OF THE INVENTION

Herbs and other grindable materials are commonly used as seasoning for food, infusions, such as tea or coffee, or material to be smoked, such as tobacco. The stem, flower, leaves, or seeds of a plant may be used as an herb and is typically ground into smaller pieces for easier use, application, or consumption. Grindable materials are defined as either plant products such as herbs, or minerals that can be broken into smaller pieces. Grindable materials may be ground to a fine powder, or simply into smaller chunks depending on the desired product. To do this, many people use a mechanical grinding device such as a pestle and mortar.

To grind large quantities of grindable materials at a time, many people use electronic or hand cranked grinders. These devices are often cumbersome, take up valuable space, and trap large amounts of grindable material residue that must then be cleaned out. In addition, such devices may make a large amount of noise and be difficult to operate comfortably.

When grinding small quantities of grindable materials, many people prefer to use their hands without relying on a grinding device. This has several advantages, including allowing the grindable materials to be directly applied to food or drink in precise quantities, as well as a satisfying tactile sensation and more precise control over how finely the materials are ground. On the other hand, disadvantages of hand grinding include a frequent need for hand washing to remove excess residue, a less sanitary grinding method, and pain or damage to the skin in the case of caustic or rough grindable materials.

### SUMMARY OF THE INVENTION

The present invention includes an apparatus for grinding herbs comprising at least one wearable grinder, having a bottom end and a top end, and having an exterior surface and an interior surface; wherein the bottom end includes a cavity configured to be worn on the digit of a person; and wherein the top end includes a grinding surface located on the exterior surface of the wearable herb grinder, said grinding surface having a texture configured for grinding.

The present invention also includes a method of grinding a grindable material comprising inserting a digit into a wearable grinder, the wearable grinder having a bottom end and a top end, and having an exterior surface and an interior surface; wherein the bottom end includes a cavity configured to be worn on the digit of a person; and wherein the top end includes a grinding surface having a texture configured for grinding located on the exterior surface of the wearable herb grinder; placing the grindable material in between the grinding surface of the wearable grinder and a secondary surface; and using the digit to induce one of pressure and friction between the grinding surface and the secondary surface.

### BRIEF DESCRIPTION OF THE DRAWINGS

The drawings are meant to illustrate the principles of the invention and do not limit the scope of the invention. The above-mentioned features and objects of the present disclosure will become more apparent with reference to the following description taken in conjunction with the accompanying drawings wherein like reference numerals denote like elements in which:

FIG. 1 is a perspective view of a first embodiment of the invention positioned on the hand of a user.

FIG. 2 is a perspective view of a second embodiment of the invention positioned on the hand of a user.

FIG. 3 is a perspective view of a third embodiment of the invention positioned on the hand of a user in the process of grinding.

FIG. 4 is a side view of a wearable grinder according to a fourth embodiment of the invention.

FIG. 5 is a perspective view of a wearable grinder according to a fifth embodiment of the invention.

FIG. 6 is a front view of a wearable herb grinder according to the embodiment of FIG. 5 positioned on the finger of a user.

FIG. 7 is a side view of a wearable grinder according to the embodiment of FIG. 5 positioned on the finger of a user.

FIG. 8 is a perspective view of a wearable grinder according to the embodiment of FIG. 2.

FIG. 9 is a perspective view of a wearable grinder according to a sixth embodiment of the invention.

### DETAILED DESCRIPTION OF THE INVENTION

Reference will now be made in detail to the exemplary embodiments of the present disclosure, examples of which are illustrated in the accompanying drawings, wherein like reference numerals refer to like elements throughout. The embodiments are described below so as to explain the present disclosure by referring to the figures. Repetitive description with respect to like elements of different exemplary embodiments may be omitted for the convenience of clarity.

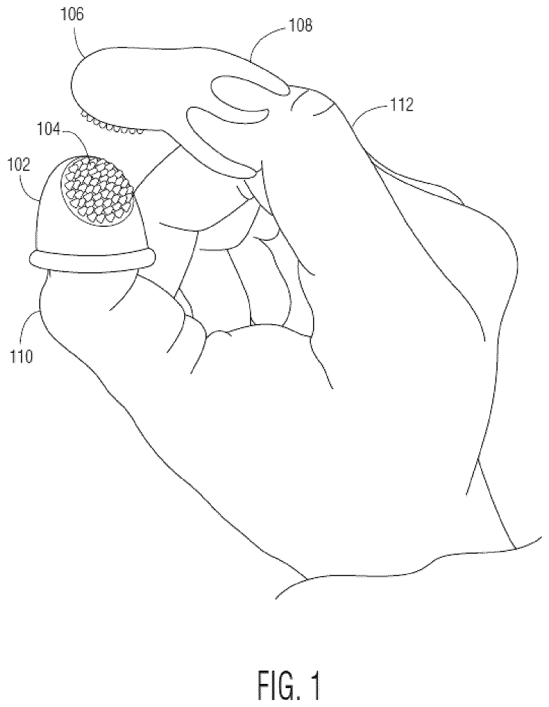

FIG. 1 illustrates one preferred embodiment of the invention in which a first wearable grinder 102 is worn on the end of a user's thumb 110 and a second wearable grinder 106 is worn on the end of a user's index finger 112. The term digit as used herein may refer to either a thumb (the first digit on a hand) or a finger (the index finger, middle finger, ring finger, or the little finger). The first wearable grinder 102 includes a grinding surface 104, which in some embodiments is grooved to provide additional friction for improved grinding. The second wearable grinder 106 includes one or more supporting members 108 which extend axially from the bottom end of the grinder. Supporting members 108 increase stability and help to prevent the grinder from slipping off the user's finger. In some embodiments, supporting members may be thinner to save on material costs and provide improved comfort without meaningfully sacrificing stability. Supporting members may also be of various shapes and styles without departing from the spirit of the present invention.

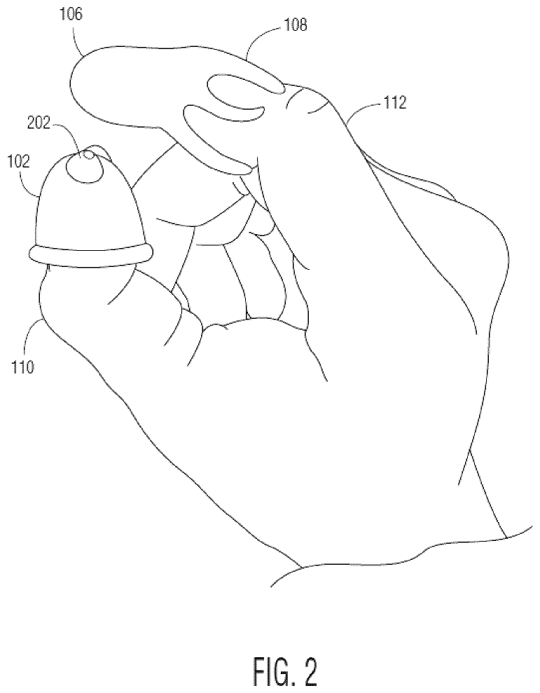

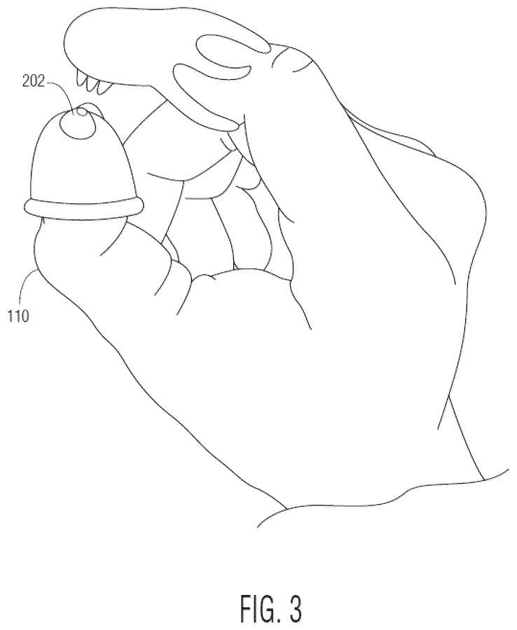

FIG. 2 illustrates yet another preferred embodiment in which the grinding surface of the first wearable grinder 102 includes at least one mound 202 which extends outwards from the external surface of the grinder. This structure helps allow the grindable material to be ground into a course product and reduces the risk of accidentally grinding the material into a fine powder. In some embodiments, such as that of FIG. 3, the user may mix and match different grinding surfaces to achieve the desired consistency of the ground material.

FIG. 3 illustrates an embodiment in the process of grinding. When grinding, the user first places grindable material in between the grinding surfaces of the wearable grinders. The user then presses together the grinding surfaces and moves them back and forth to induce friction. In this preferred embodiment, the user wears the first wearable grinder on his or her thumb 110 and the second on his or her index finger 112 of the same hand, which allows for easy and clean grinding, but many other configurations may be considered. Alternatively, the user may wear the first wearable grinder on his or her thumb, and the second grinder on the middle finger, the ring finger, or the little finger. For example, and without limitation, the user may choose to wear a single grinder on his or her thumb and press the grinding surface against the tip of his or her index finger. In other embodiments, the user may wear more than two wearable grinders or wear the first on a left-hand digit and the second on a right hand digit. A digit is defined as any finger or thumb on any hand.

While using two or more wearable grinders together is generally preferred, other methods of grinding are also within the scope of the invention. For example, the user may wish to use a single grinder by inducing friction between that grinder's grinding surface and a secondary surface. This may be preferable in some cases, such as if the user wishes to keep the grindable material in a bowl or on a cutting board. Depending on the friction of the secondary surface, the user may also achieve a unique consistency in the final ground material.

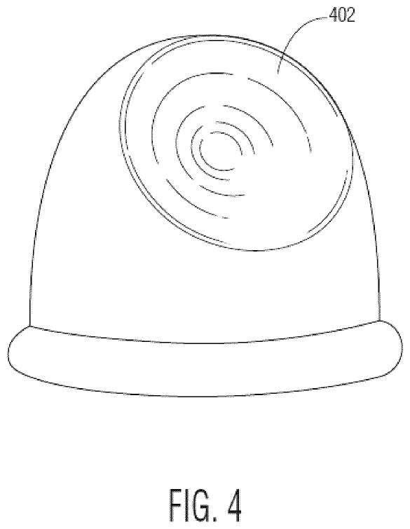

FIG. 4 illustrates yet another embodiment of the invention. In this embodiment, the grinding surface includes a divot 114 that bends inwardly such that the grinding surface is below the external surface of the grinder. This allows the divot 402 to serve as a receptacle for the grindable material and helps to prevent spillage. In some embodiments, the grinding surface may be smooth to prevent grindable material from becoming trapped in the divot 402. In other embodiments, the grinding surface may include bumps, ridges, or mounds for maximum friction.

The user may wish to place the divot 402 below a secondary grinding surface, such as that of another wearable grinder. By doing this, the user can easily transport the ground material to a desired location after grinding is complete. In other embodiments, the divot may be placed above or at a different angle to the secondary grinding surface.

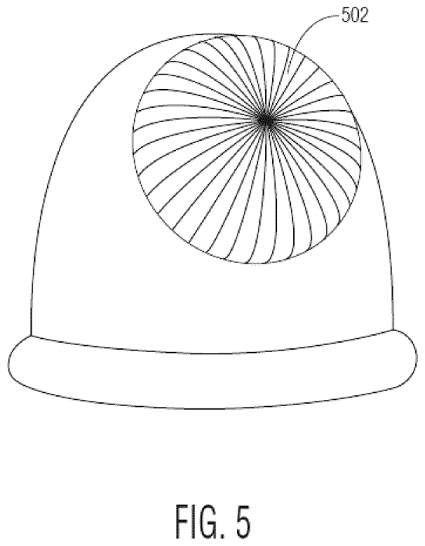

FIG. 5 illustrates yet another embodiment of the invention in which the grinding surface of the wearable grinder includes ridges 502 that extend radially from the center of the grinding surface. In this embodiment, the grooves may be straight and may extend all the way to the edge of the grinding surface. In other embodiments, the grooves may curve or cross one another in order to produce unique consistencies in the final ground product. Each of these configurations of the grooves is included in the present invention.

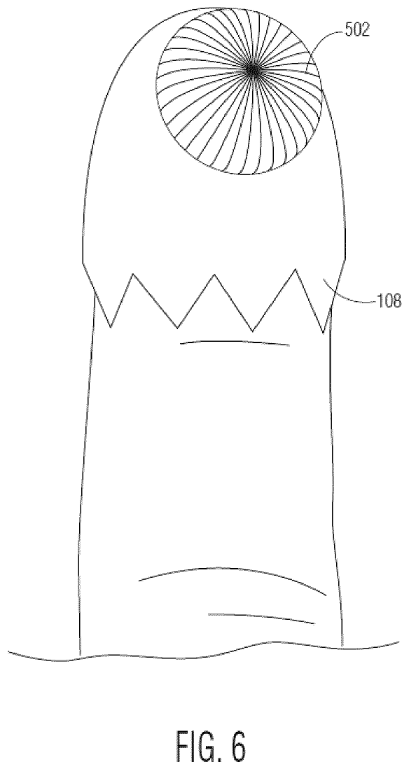

FIG. 6 illustrates an embodiment of the invention having a grinding surface with the same ridges 502 as FIG. 5 worn on a user's finger.

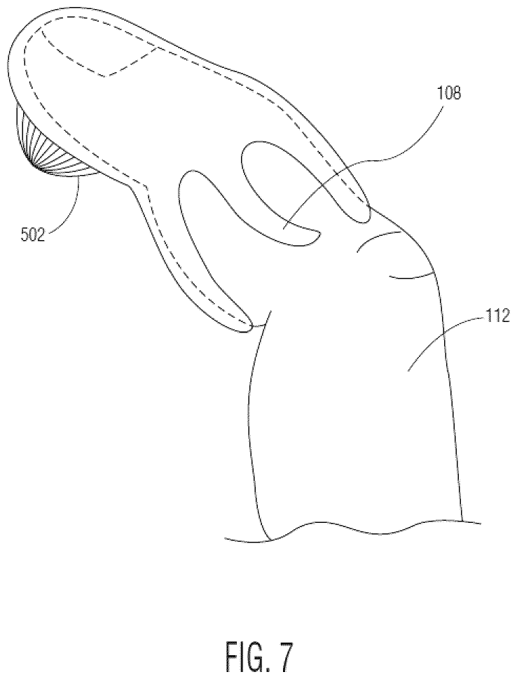

FIG. 7 illustrates an additional embodiment of the invention in which the wearable grinder includes a plurality of supporting members 108. Supporting members may vary in size or shape to support various digits. In FIG. 7, the supporting members 108 are uniform in length and tooth-like in shape and the wearable grinder is worn on, for example, the user's thumb. In FIG. 7, the supporting members 108 are long and varied in both shape and length. Longer, varied supporting members are generally preferred to support longer digits such as the user's index finger 112, while shorter, tooth-like supporting members, such as those in FIG. 6, are generally ideal for supporting the user's thumb 110. However, user preference may dictate a different configuration to ensure comfort and ease of use.

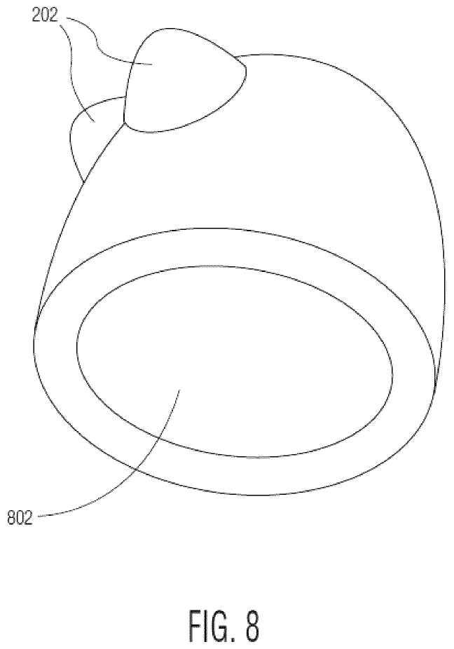

FIG. 8 illustrates the first wearable grinder of FIG. 2 as it appears when not being worn on the digit of a person. The first wearable grinder includes on its bottom end a cavity 802 configured to receive a digit, and near its top end it includes a grinding surface with at least, in this embodiment, two protruding mounds 202. The placement of the grinding surface may vary to allow for different grinding angles, but in one preferred embodiment, it is located near the top end of the grinder. This allows for maximum control and ease of use. However, various other sizes and placements are included within the scope of this invention to accommodate disability or user preference.

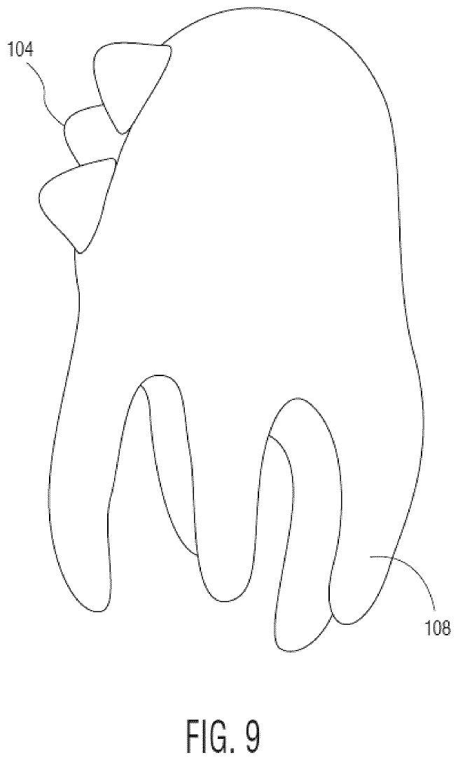

FIG. 9 illustrates a wearable grinder of yet another embodiment of the invention as it appears when not worn on the digit of the user.

Unless defined otherwise, all technical terms used herein have the same meaning as commonly understood by one of ordinary skill in the art to which this invention belongs. Any methods and materials similar or equivalent to those described herein also can be used in the practice or testing of the present disclosure.

While the present disclosure has been described with reference to the specific embodiments thereof, it should be understood by those skilled in the art that various changes may be made and equivalents may be substituted without departing from the true spirit and scope of the invention. In addition, many modifications may be made to adopt a particular situation, material, composition of matter, process, process step or steps, to the objective spirit and scope of the present disclosure. All such modifications are intended to be within the scope of the claims appended hereto.

What is claimed is:

1. An apparatus for grinding herbs comprising:
at least one wearable grinder, having a bottom end and a top end, and having an exterior surface and an interior surface; wherein the bottom end includes a cavity configured to be worn on the digit of a person; and wherein the top end includes a grinding surface located on the exterior surface of the wearable herb grinder, said grinding surface having a texture configured for grinding.

2. The apparatus of claim 1, wherein the bottom end of the wearable grinder terminates in at least one supporting member which extends axially from said bottom end.

3. The apparatus of claim 1, wherein the grinding surface includes at least two mounds, which protrude outwardly from the exterior surface of the wearable grinder.

4. The apparatus of claim 1, wherein the grinding surface includes at least one ridge, said ridge extending radially from the center of the grinding surface to edge of the grinding surface.

5. The apparatus of claim 1, wherein the grinding surface includes a divot with an exterior surface that is below the exterior surface of the wearable herb grinder.

6. A method of grinding a grindable material comprising:
inserting a digit into a wearable grinder, said wearable grinder having a bottom end and a top end, and having an exterior surface and an interior surface; wherein the bottom end includes a cavity configured to be worn on the digit of a person; and wherein the top end includes a grinding surface having a texture configured for grinding located on the exterior surface of the wearable herb grinder;
placing a grindable material in between the grinding surface of the wearable grinder and a secondary surface; and
using said digit to induce one of pressure and friction between the grinding surface and the secondary surface.

7. The method of claim 6, wherein the bottom end of the wearable grinder terminates in at least one supporting member which extends axially from said bottom end.

8. The method of claim 6, wherein the grinding surface includes at least two mounds, which protrude outwardly from the exterior surface of the wearable grinder.

9. The method of claim 6, wherein the grinding surface includes at least one ridge, said ridge extending radially from the center of the grinding surface to edge of the grinding surface.

10. The method of claim 6, wherein the grinding surface includes a divot with an exterior surface that is below the exterior surface of the wearable herb grinder.
